(19) United States
(12) Patent Application Publication
(10) Pub. No.: US 2001/0043234 A1
(43) Pub. Date: Nov. 22, 2001

(54) Incorporating non-native user interface mechanisms into a user interface

(76) Inventor: Mallik Kotamarti, Cupertino, CA (US)

Correspondence Address: Hickman Palermo Truong & Becker, LLP, 1600 Willow Street, San Jose, CA, 95125-5106, US

(21) Appl. No.: 09/754,012

(22) Filed: Jan. 2, 2001

Related U.S. Application Data
(60) Provisional application No. 60/174,279, filed on Jan. 3, 2000.

(51) Int. Cl. G06F 13/00

(52) U.S. Cl. 345/746; 345/744

(57) ABSTRACT

A method and apparatus for enabling access to an interface is provided. In an embodiment, a process is provided for examining the description of a particular user interface to generate a projection of the user interface that provides user interface mechanisms not described by the description. The user may interact with the user interface mechanisms to access functions and content that is otherwise available through the particular user interface. For example, a web page contains code written in HTML. The HTML code defines user controls which are displayed to a user and which may be manipulated by the user with a mouse to access functionality provided by the GUI. The techniques described herein may be used to generate an audio projection of the GUI, and in particular, to generate a user interface through which the user may access functionality and content of the GUI using audio modalities, to hear the GUI's content, and to access its functions using commands conveyed by the user audibly. The projections are accomplished through the use of code modules that (1) describe how to examine the description of a user interface to generate a projection of it, and (2) that define macros associated with instructions and user commands that may be used to invoke the macros. The instructions specify operations to perform with respect to the user interface and/or its description.

### RELATED APPLICATION

This application is related to and claims priority from prior U.S. Provisional Patent Application Serial No. 60/174,279 filed on Jan. 3, 1999, entitled “A System of Voice Access to the Internet”, by inventor Mallik Kotamarti, the entire disclosure of which is hereby incorporated by reference as if fully set forth herein.

### FIELD OF THE INVENTION

The present invention relates to user interfaces used to access network resources, and in particular, a method for enabling access to an interface by generating user interfaces from a description of another user interface to provide interface mechanisms different than those provided by the other user interface.

### BACKGROUND OF THE INVENTION

Before the proliferation of Internet usage by the public at large, the Internet was accessed using text command driven based interfaces. Text command driven based interfaces would accept text commands and parameters entered by a user that specified what information to retrieve, and then retrieve the information. These interfaces were very cumbersome to use, especially for mainstream users, and even for computer professionals.

Eventually a new Internet technology emerged that opened up the Internet to mainstream users. This new technology involved the incorporation of a graphical user interface (GUI) with a browser, herein referred to as a GUI browser. A browser, such as a GUI browser, is software that is capable of downloading pages containing code and generating an interface based on the downloaded code. A page is a unit of data (for example, a file) that is transmitted to a client and that may be executed by a browser. Often, the code describes a GUI. A GUI browser interprets the code, and in response to interpreting the code, generates a GUI. The code is written in a computer language, such as the hypertext markup language (HTML). The page not only specifies what text or graphical information to present and how to present it, but may specify links to access other sources on the Internet, including other pages. HTML and its various dialects are described in, for example, the document HTML 4.01 Specification, recommended by the W3C Consortium on Dec. 29, 1999 and herein incorporated by reference, and the document XHTML™ 1.0: The Extensible HyperText Markup Language, recommended by the W3C Consortium on Jan. 26, 2000 and herein incorporated by reference.

A GUI browser is much easier to use than a text command driven interface. To access the Internet, a user issues commands by manipulating easily recognized graphical controls rendered on a display with a mouse. Mainstream users, unencumbered by text command driven interfaces and empowered by GUIs, have accessed the Internet more often and in greater numbers using GUI browsers. This has unleashed an even greater demand and reliance on information obtainable over the Internet, information such as the news, stock prices, and reference material.

Internet technologies that later evolved facilitated the development and deployment of applications that could be executed on GUI browsers. The applications allowed users to interact more easily and securely with servers operated on behalf of, for example, merchants. Thus the Internet emerged as a new and potent medium for consumer interaction with merchants of products and services. Mainstream users could access these applications, at a time convenient to them, to learn not only about products, services, and pricing, but to order products and services.

Initially, users accessed the Internet from personal computers at home or at work. Although computers are, for all practical purposes, ubiquitous, they are nevertheless immobile. The immobility of personal computers confined user Internet access to wherever a user could “get their hands on” a personal computer connected to the Internet.

Eventually networking technologies evolved that allowed users to access the Internet through mobile devices. Wireless technologies, for example, allowed a user to connect to the Internet using mobile devices, such as personal data assistants or digital phones. While these technologies expanded the reach of a user's ability to access the Internet, the interfaces provided by these mobile devices were more limited as compared to GUIs that were available on a personal computer. For example, the small LCD and keypad of a mobile telephone provided far less functionality than could be obtained from a GUI operating on a computer with a graphical display, mouse, and full keyboard.

A user interface uses a modality of interaction to communicate with a user. The term modality of interaction refers to a form of interaction between a human and an apparatus that requires a particular capability of a human individual to interface with a particular type of device. Examples of modalities of interaction include (1) the graphical modality, which requires the human capability to view a graphical display generated by a graphical display mechanism (2) the mouse manipulation modality, which requires the human capability to manipulate a mouse, (3) the listening modality, which requires the human capability to listen to sound generated from an audio output system that may include a speaker and a sound card, (4) or the voice modality, which requires the human capability to speak utterances to an audio input system that may include a microphone or sound card. Modalities of interaction, such as the listening modality and voice modality are referred to herein as audio modalities because they are based on the hearing and speaking abilities of human individuals. A graphically enabled interface is an interface that uses a graphical modality. An audio enabled interface is an interface that uses an audio modality.

To enhance the interface capabilities of mobile phones, Internet resources are designed so that they may be accessed using voice-enabled interfaces. One technique for providing voice-enabled interfaces is to develop pages that contain code that describe voice-enabled interfaces, where the code defines, according to a computer language definition, interfaces mechanisms that use audio modalities. One such language is the Voice Extensible Markup Language (VXML).

For example, a user telephones into a telephone portal. A telephone portal is a voice-enabled interface accessed by a user via a phone to access the Internet. The telephone portal runs a browser that downloads pages that may be written in VXML. The browser interprets the interface, generating a voice-enabled interface to the user. The browser accepts voice commands defined by VXML and performs operations defined for the voice commands. VXML is described in the document Voice extensible Markup Language (VoiceXML) Version 1.0 Specification, submitted May 2000 to the W3C Consortium.

While VXML enables developers to develop interfaces that are voice-enabled, the need and demand by mainstream users for GUI interfaces remained. Thus, any organization that developed and maintained Internet resources provided access to those resources through GUIs. If the organization desired to provide access through voice-enabled interfaces, these interfaces were developed in addition to GUI interfaces. Developing and maintaining voice-enabled interfaces usually entailed additional effort and cost to develop and maintain both voice-enabled and graphically enabled interfaces.

Because of the extra cost, many organizations forgo developing voice-enabled interfaces using VXML. The additional cost thus impedes the growth and adoption of voice-enabled interfaces, and hinders growth of new businesses that supply voice-enabled interfaces for mobile telephones or other devices, such as operators of telephone portals.

Based on the foregoing, it is clearly desirable to provide a method and mechanism that allows a preexisting interface to be voice-enabled without having to alter the code defining the interface or having to depend on third parties to alter the code. In addition, it is clearly desirable to provide an interface that allows access to another interface using interfaces mechanisms and modalities of interaction not defined by the other interface.

### SUMMARY OF THE INVENTION

A method for enabling access to an interface is described. Discussed herein are techniques for examining the description of a particular user interface to generate a projection of the user interface that provides user interface mechanisms not described by the description of the user interface. The user may interact with the user interface mechanisms to access functions and content that is otherwise available through the particular user interface. For example, a web page contains code written in HTML. The HTML code defines user controls which are displayed to a user and which may be manipulated by the user with a mouse to access functionality provided by the GUI. The techniques described herein may be used to generate an audio projection of the GUI, and in particular, to generate a user interface through which the user may access functionality and content of the GUI using audio modalities, to hear the GUI's content, and to access its functions using commands conveyed by the user audibly. The projections are accomplished through the use of code modules that (1) describe how to examine the description of a user interface to generate a projection of it, and (2) that define macros associated with instructions and user commands that may be used to invoke the macros. The instructions specify operations to perform with respect to the user interface and/or its description.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram depicting metacode in a metamodule that defines presets;

FIG. 2 is a diagram depicting metacode in a metamodule that defines presets;

FIG. 3 is a diagram depicting an exemplary architecture;

FIG. 4 is a flowchart depicting steps of a process for executing metacode;

FIG. 5 is a flowchart depicting steps of a process for executing metacode;

FIG. 6 is a flowchart depicting steps of a process for executing metacode;

FIG. 7 is a diagram depicting an exemplary architecture of an embodiment;

FIG. 8 is a diagram depicting an exemplary architecture of an embodiment; and

FIG. 9 is a block diagram of a computer system that may be used to implement an embodiment.

### DETAILED DESCRIPTION OF THE PREFERRED EMBODIMENT

A method for enabling access to an interface is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### OVERVIEW

Discussed herein are techniques for examining the description of an “adapted” user interface to generate and present a “projected” user interface to a user. The terms “projected” and “project” refers to providing non-native mechanisms with which the user may interact to access functions and content accessible through the adapted user interface. Non-native mechanisms refers to mechanisms or functionality that are not defined by the code and data that describe a user interface according to the computer language to which the code and data conforms. For example, a web page contains code written in HTML. The HTML code defines user controls which are displayed to a user and which may be manipulated by the user with a mouse to access functionality provided by the GUI. The techniques described herein may be used to generate an audio projection of the GUI, and in particular, to generate a user interface through which the user may access functionality and content of the GUI using audio modalities, to hear the GUI's content, and to access its functions using commands conveyed by the user audibly.

Generation of a projected interface is accomplished through the use of metamodules that contain metacode. Metacode is code and data that (1) describes how to examine the description of an adapted interface to generate a projected interface, and (2) that defines macros associated with instructions and user commands that may be issued to invoke the macros. The instructions specify operations to perform with respect to the adapted interface and/or its description. The Metacode conforms to a metacode language. The metacode language commands and format shall be described later.

Metamodules that contain metacode are executed by a metabrowser. A metabrowser allows a user to access an adapted interface through a projected interface generated by the metabrowser in response to executing a metamodule that is associated with an adapted interface. A metabrowser may, for example, allow a user to access a web page through a telephone portal.

When a user calls the telephone portal, a metabrowser executes a metamodule associated with the user. The metamodule contains presets which serve as macros. A preset is a group of metacode instructions that are executed by a metabrowser upon the occurrence of an event, such as the receipt of a voice command associated with the preset. A preset may also identify a current page. The commands in a preset typically operate upon the current page.

The techniques described herein for projecting interfaces are illustrated by describing techniques that audio enable adapted interfaces. However, interfaces may be projected in other ways that use modalities of interaction other than audio modalities, as shall be later described.

When the metabrowser commences execution of a metamodule, it scans the metamodule to determine the presets contained in the metamodule, and the voice commands associated with each preset. Next, the metabrowser executes an “entry” preset, and awaits receipt of messages specifying a voice command issued by a user. These voice commands may be any of those defined for the presets in the module, or any voice commands defined by a language disclosed herein and referred to as Lingo.

Lingo is a computer language that defines a set of voice commands and set of associated operations to be performed by a metabrowser. Many of the operations correspond to those that may be requested by a user interacting with a GUI browser. For example, the Lingo voice command ‘Reload’ corresponds to the reload operation in Navigator or Internet Explorer. Lingo commands are described in greater detail in Appendix B. Metacode instructions may contain Lingo commands.

The metabrowser is described herein as receiving various types of user inputs and generating various user outputs. A user may provide input by making utterances through a phone or depressing the phone keypad to generate dual-tone multi-frequency (“DTMF”) signals. These types of input are directed to a sound engine, which is a combination of software and hardware components, interposed between the metabrowser and the user, which translate the user input on behalf of the metabrowser into strings that correspond to words and phrases. Many sound engines recognize a set of phrases referred to herein as a vocabulary. A metabrowser may control the vocabulary of the sound engine by providing it with vocabulary input that defines the vocabulary. Vocabulary input may be a set of strings that specify the phrases of the vocabulary.

The strings representing input that the sound engine transmits to a metabrowser are referred to herein as user input strings. User input strings that identify commands recognized by a metabrowser are referred to as user commands. User commands that originate from user voice input are referred to as voice commands. When the metabrowser receives a voice command, it receives a message containing a string identifying a command from the software and hardware components translating user input.

Likewise, when the metabrowser generates output for the user, it generates messages that contain strings that are transmitted to the sound engine. The sound engine translates the strings into a form of audio data that may be communicated to the user. In addition, the string may identify files containing digital audio data, such as “*.wav” files. Such “wav” files use an audio format developed jointly by Microsoft Corporation and IBM Corporation. The messages, when generated by a metabrowser, are referred to herein as user audio output.

### EXEMPLARY METACODE DEFINITION

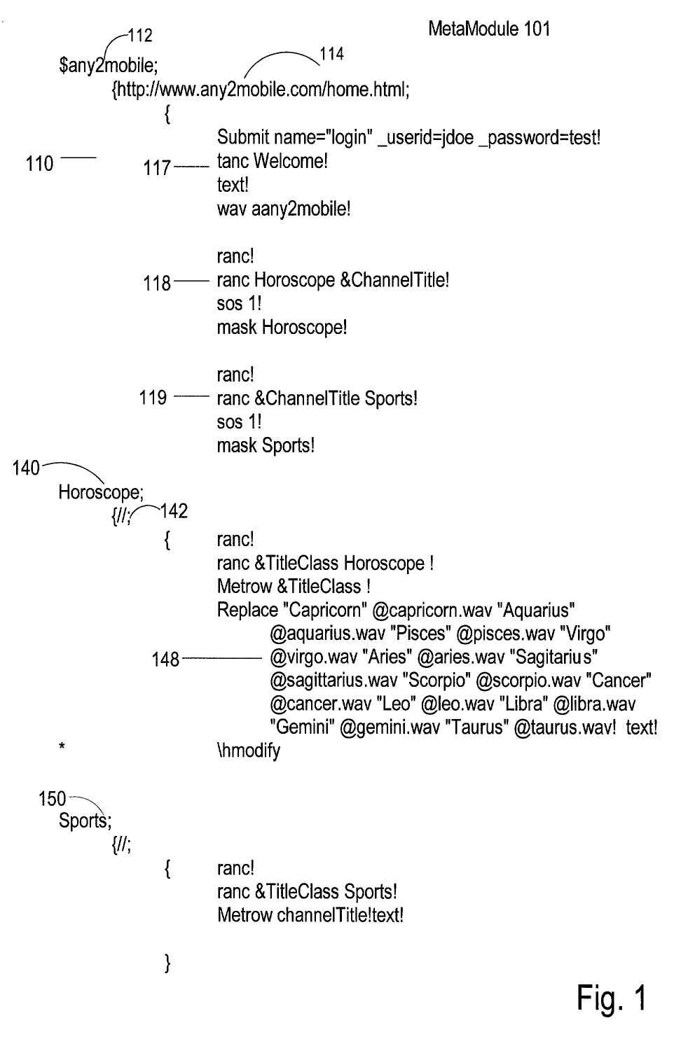

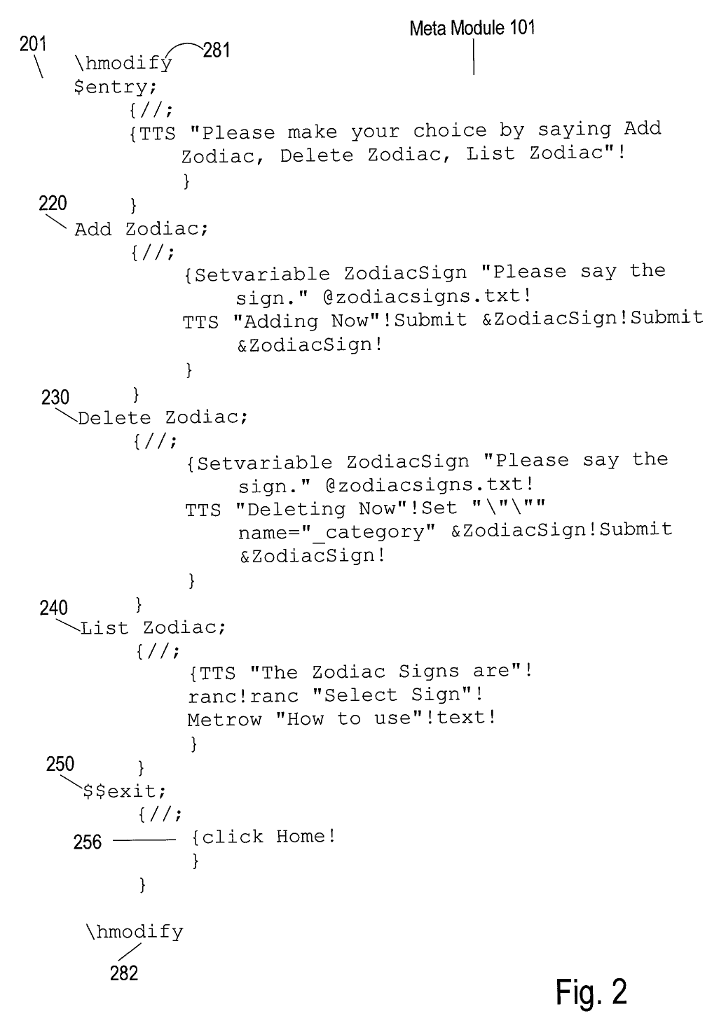

The following notation in Table A describes the syntax and format defined by the metacode language according to an embodiment. An exemplary metamodule with presets is depicted in FIG. 1 and FIG. 2. These presets are used to not only illustrate the syntax and format of the metacode language, but to illustrate the operations specified by some commands defined by the metacode language. These metacode commands will be described to the extent needed to facilitate illustration of the presets depicted in FIG. 1 and FIG. 2. Additional details about the metacode language may be found in Appendix A.

TABLE A
METACODE FORMAT DEFINITION

<Metamodule>:= {<Line>, }
<Line>:= <comment line>|<preset>
<Comment>:= <‘*’>
<Preset>:= <entry preset>|<body preset>|<exit preset>|<link to other
Metamodule file>|
<link to other Metamodule>|:= ‘@’<Preset ID><Metamodule identifier>
<entry preset>:= <‘$’><body preset>
<exit preset>:= <‘$’><‘$’><body preset>
<body preset>:= <<Preset ID><alternate ID>[<macro block>]>|
<<Preset ID><macro block>
<Preset ID>:= string
<alternate ID>:= <=<macro>>
<Macro block>:= <column-delimiter><URL><col-delimiter><macro><end-of-
line>>
<URL>:= string
<column-delimiter>:= ‘;’
<macro>:= <command-list>
<command-list>:= <instruction>|<instruction><command-delimiter><command-
instruction>
<command-delimiter>:= ‘!’
<command-instruction>:= <command><>|<command><parameter-list>
<parameter-list>:= <parmeter>|<parameter><parameter-delimiter><parameter-
list>
<parameter-delimiter>:= ‘,’

FIG. 1 shows a portion of metamodule 101. Referring to FIG. 1, metamodule 101 contains preset $any2mobile 110, Horoscope 140, Sports 150, and $$Exit. Preset $any2mobile 110 is an example of an entry preset. Preset $any2mobile is executed when metamodule 101 is loaded in a manner to be described in greater detail. To designate $any2mobile as an entry preset, a ‘$’ character is prefixed to the preset identifier 112 of $any2mobile 110. In like manner, the prefix ‘$$’ is used to designate $$exit 160 as an exit preset. An exit preset is executed in a manner that shall be later described. The prefixes and preset names in this description are provided for the purpose of illustrating an example; however, embodiments are not restricted to the specific prefixes and preset names that are used. Likewise, for purposes of illustrating examples, the use of embodiments for presenting horoscope information and sports information is described; however, embodiments are not limited to presentation of such information. Any desired information may be presented using the techniques and embodiments described herein.

The other presets shown in FIG. 1 are body presets. A preset identifier of a body preset, such as Horoscope 140, and Sports 150, not only identifies the preset, but specifies the voice command that will cause the metabrowser to invoke a preset. For example, the preset identifier of Horoscope 140 is the string “Horoscope.” When a user issues the voice command ‘Horoscope’ while a metabrowser is running metamodule 101, the metabrowser executes preset Horoscope 140.

A preset defines other user commands that may be used to invoke a body preset. A preset may have an alternative identifier, which specifies another voice command that may be used to invoke the preset. In addition, a user command in the form of a DTMF code may be used to invoke a body preset. A body preset is associated with the DTMF code that corresponds to the preset's position in a metamodule relative to other presets. For example, the DTMF code that corresponds to number 3 on a telephone key pad may be used to invoke the third body preset shown in FIG. 1.

In preset $any2mobile 110, command-list 116 is the set of instructions included in a preset. Command-list 116 includes blocks 117, 118, 119. Each of blocks 117, 118, 119 contain instructions that are each separated by the character ‘!’. Of course, a different separator character could be used.

When execution of $any2mobile 110 commences, the metabrowser loads the page identified by URL 114. URL 114 is a uniform resource locator (URL) that specifies the current page. Instructions executed by a metabrowser that operate on a page operate on the current page. Because blocks 117, 118, and 119 are in an entry preset, these blocks are executed when execution of metamodule 101 by a metabrowser commences.

The first instruction executed is the first instruction in the first line of block 117. This instruction specifies the Text Anchor (“tanc”) command and the parameter string ‘Welcome’. The tanc command causes a metabrowser to find a text clip containing ‘Welcome’ in the current page, such as a block containing ‘Welcome John Doe’. A copy of the text is placed in an “audio output buffer”. An audio output buffer logically contains data, such as text and digital audio data files, to be outputted later as user audio output, when, for example, the metabrowser encounters an instruction specifying the text command.

The next instruction in block 117 contains the text command, which causes the contents of the audio output buffer to be output as user audio output. For example, if the audio output buffer contains the text “Welcome John Doe’, an instruction containing the command text will cause the text in the audio output buffer to be output to a user over the phone as user audio output. The last instruction in block 117 contains the wav command, which causes a file identified by a parameter containing digital audio data to be output as user audio output. Thus the last instruction in block 117 causes the file in any2mobile.wav to be played to the user over the phone.

The first instruction in block 118 includes the Row Anchor (“ranc”) command. The ranc command causes a row in a table in the current page to be established as the current row. Other commands specify operations that operate on the current row. HTML provides for table data structures with columns and rows. To execute an instruction containing the command, the metabrowser examines HTML code in the page that defines the table structures. When an instruction specifies no parameter for the ranc command, then the result of executing the instruction is that no row is established as the current row.

The next instruction in block 118, which includes the ranc command, specifies the parameter string values ‘Horoscope’ and ‘ChannelTitle’. When an instruction specifies one or more parameter string values, then the next row following the current row that contains all the string values is established as the current row. When there is no current row, then the search for the next row begins with the first row in the first table defined by the current page.

The next instruction in block 118 specifies the Skip On Success (“sos”) command. This command specifies that the next N instructions are not to be executed if the preceding instruction was executed successfully, where N is a parameter for the sos command. In the case of an instruction specifying the ranc command, the instruction is executed successfully if a row is established as a current row. For purposes of illustration, assume that the previous instruction did not find a row containing ‘Horoscope’ and ‘ChannelTitle’, and thus did not execute successfully. As a result, the following SOS command causes the instruction to be executed.

The following instruction contains the mask command, and a string parameter. The mask instruction specifies that the preset identified by the string parameter is not active. The term active, when used to refer to a set of presets, denotes that the preset is executed when a user issues a voice command associated with the preset. The term inactive, when used to refer to a set of presets, denotes that the preset will not be executed when a user issues a voice command associated with the preset. The term activate or deactivate refers to operations that cause a preset to be active or inactive, respectively. The terms activate or deactivate, when used to refer to commands that may be issued to invoke a preset, refer to inactivating or deactivating that preset. Activation may include transmitting vocabulary input to extend the vocabulary of a sound engine to include the phrases for the voice commands of activated presets. Deactivation may include transmitting input to a sound engine to remove phrases for voice commands from the vocabulary of a sound engine.

The mask command, when used in conjunction with other commands that control whether instructions are executed or not, is useful for generating projected interfaces that reflect the customizations of personalized web pages generated for particular users. For example, a dynamically generated web page generated for one user may not contain a row that has the text ‘HOROSCOPE’. In this case, the instruction containing the mask command in block 118 will not be skipped, causing the preset HOROSCOPE 140 to be inactive. However, another dynamically generated web page generated for another user does contain a row that has the text ‘HOROSCOPE’. In this case, the instruction containing the mask command in block 118 will be skipped, allowing preset HOROSCOPE 140 to remain active.

Block 119 contains instructions that operate similar to those in block 118. Executing the instructions in block 119 may cause preset Sports 150 to be active or inactive depending on whether or not the current page has a row containing the strings ‘ChannelTitle’ and ‘Sports’.

The preset Horoscope 140 includes URL 142 and block 148. The URL 142 contains ‘//’, which specifies that the current page is the page that was current when the preset was invoked.

Execution of the first instruction establishes as the current row the first row in the current page containing the strings ‘ChannelTitle’ and ‘Sports’. The following instruction contains the command metrow, and specifies as a parameter the string value ‘TitleClass’. The metrow command specifies that the text in a set of rows should be loaded in the audio output buffer, where the set of rows includes rows between the current row and the next row that contains the parameter string value. The following instruction contains the text instruction, which specifies that the contents of the audio output buffer should be output as user audio output.

The last instruction in block 148 includes a submenu instruction. A submenu instruction has the form of character ‘\’ followed by a string identifier that identifies a submenu module. Submenus are described in further detail below.

### MENUS AND SUBMENUS

A metamodule 101 defines a preset menu and may define one or more submenus. A preset menu is a set of commands that may be invoked by a user through an interface. A preset menu is a set of user commands associated with a set of presets, that each may be executed in response to receiving a user command that identifies the preset. A submenu is a preset menu that is activated when a user command is issued. For example, a preset menu and its associated presets are activated by the voice commands “News” and “Weather”. When a user issues the voice command “News” and its associated preset is executed, the metabrowser encounters the submenu instruction identifying the submenu module “News List”. News contains presets associated with voice commands “National”, “Sports”, and “Hi Tech”.

FIG. 2 shows the portion of metamodule 101 that includes submenu module hmodify 201. A pair of submenu instructions outside the scope of any preset demarcates the code that defines a submenu module. Submenu instructions 281, 282 demarcate the beginning and end of the block of metacode that defines a Horoscope Modify submenu module hmodify 201. A submenu module may include an entry preset, an exit preset, and body presets. Submenu module hmodify 201 includes preset $entry 210, preset $$exit 250, and body presets Add Zodiac 220, Delete Zodiac 230, and List Zodiac 240. When a metabrowser encounters a submenu instruction during execution of the instruction-list of a preset, the metabrowser executes the entry preset defined for the submenu module and activates the exit preset and body presets described by the submenu module.

The following example is provided to illustrate how a metabrowser processes a submenu. When execution of the submenu module hmodify 201 is commenced, the metabrowser executes the instruction 216 in $entry 210. This instruction contains the TTY command and the string parameter value ‘Please make your choice by saying Add Zodiac, Delete Zodiac, List Zodiac’. The TTY command specifies that the parameter string value is to be output as user audio output.

After execution of the $entry 210, the presets 220, 230, 240, and 250 are activated. When the user issues the voice command “Add Zodiac”, preset Add Zodiac 220 is executed. When the user issues the voice command “Delete Zodiac”, Delete Zodiac 230 is executed. When the user issues the voice command “List Zodiac”, List Zodiac 240 is executed. A further explanation of how a metabrowser responds to the instructions in Add Zodiac 220, Delete Zodiac 230, List Zodiac 240 may be found in Appendix A. Instruction 256 contains the lingo command ‘click’, which is further explained in Appendix B.

A metamodule defines a “menu hierarchy” between a metamodule's preset menu and submenus. Each level in the hierarchy corresponds to a “menu level”: the top level corresponds to the preset menu for the metamodule, and lower levels correspond to submenus below the preset menu in the hierarchy. Each voice command associated with a preset not in the scope of a submenu module defined by a metamodule belongs to the preset menu for a metamodule. For example, metamodule 101 defines a hierarchy between hmodify 201 and the top level preset menu formed by $any2mobile 110, Horoscope 140, Sports 150, and $$exit 160. If, for example, the preset List Zodiac 240 contained the submenu instruction identifying submenu X, then submenu X would be one preset menu level below the preset menu level corresponding to List Zodiac 240.

### EXEMPLARY ARCHITECTURE

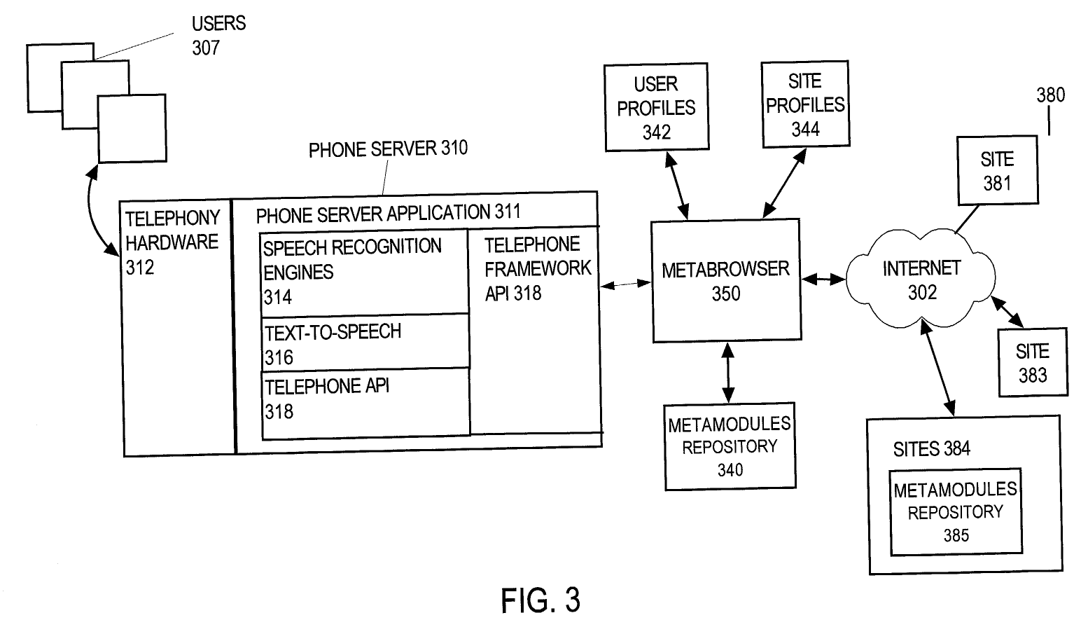

FIG. 3 is a block diagram depicting an exemplary system architecture in which voice-enabled user interfaces provide access to Sites 380 connected to Internet 302. Referring to FIG. 3, Phone Server 310 is a combination of one or more servers, software, and telephony hardware that are interposed between Metabrowser 350 and Users 307. Users 307 communicate with Phone Server 310 over a phone network. Phone server 310 enables and facilities audio communication over a phone connection between users and Metabrowser 350. Each of Sites 380 is a collection of resources, residing on one or more servers, which may be addressed for access over a network using a domain name. A domain name is a text identifier that identifies a set or one or more IP addresses of one or more servers in a domain. Examples of domain names are ‘Yahoo.com’ or ‘uspto.gov’.

Phone server 310 includes Telephony Hardware 312 and Phone Server Application 311, which interact with each other through Telephony API 318. An API is an application programming interface, which is a set of software routines, functions, and/or rules through which applications interact. Telephony Hardware 312 receives telephone phone transmissions over a phone network to Phone server 310 and transmits information about the telephone transmissions through Telephone API 318 to Phone Server Application 311. Such information includes digital audio data streams representing the voice input of a user, and data representing DTMF signals, and data identifying the user, such as the telephone number of the telephone from which telephone transmissions originate. Likewise, Phone Server Application 311 transmits digital audio data through Telephone API 318 to Telephony Hardware 312 for transmission over the phone network to the telephones of Users 307.

Phone Server Application 311 interacts with Metabrowser 350 through Telephone Framework API 320 to provide a variety of services to Metabrowser 350. Phone Server Application 311 translates digital audio data it receives representing speech of a user into text data, which is transmitted to Metabrowser 350 through Telephone API 318. To perform this translation, Phone Server Application 311 may use Speech Recognition Engine 314, which converts digital audio data into text data representing speech. Likewise, Phone Server Application 311 receives text data, from the Metabrowser 350 through Telephone Framework API 320, to communicate as audio to the user. Phone Server 310 uses Text-To-Speech-Engine 316 to convert the text data into digital audio data. In addition, Metabrowser 350 may supply digital audio data for communication to a user. The Phone Server 310 supplies the digital audio data, whether the digital audio data is supplied by Metabrowser 350 or derived from text data supplied by Metabrowser 350, to telephone hardware for communication to a user.

Telephony Hardware 312, Speech Recognition Engine 314, Text-to-Speech Engine 316 and Telephone API 318 may be off-the-shelf software and hardware products supplied by third parties. For example, Telephony Hardware 312 maybe products such as LSI/161SC telephony boards by Dialogic Corporation or AG2000 telephony boards by Natural Microsystems Corporation. The Text-To-Speech Engine 316 may be such products as RealSpeak, provided by Lernout & Hauspie Speech Products N.V., or Microsoft TTS Engine, provided by Microsoft Corporation. Speech Recognition Engine 314 may be products such as Nuance, provided by Nuance Corporation, or Voice Xpress Professional, provided by Lernout & Hauspie.

Metabrowser 350 may access metamodules from a variety of sources. One source is Metamodule Repository 340, which is coupled to Metabrowser 350. Metamodule Repository 340 is a repository of metamodules. A repository of Metamodules may be, for example, files stored in a disk directory system, or code modules stored as objects in a database system. Metabrowser 350 may access metamodules that are stored at a site. Site 384 includes Site Metamodule Repository 385.

Metabrowser 350 is also coupled to User Profiles 342 and Site Profiles 344. User Profiles 342 is a database defining attributes of users. For example, User Profiles 342 may store data that may be used to identify users, such as user telephone phone numbers, data that specifies a metamodule to invoke for users when the users use Metabrowser 350 to access a site, and data that specifies personal information about users. Personal information may include user names, and social security numbers. User profiles 342 may also contain personal wallet data. Personal wallet data can include payment information, a digital certificate to identify the user, and shipping information to speed transactions. Personal wallet data may be provided to site by a metabrowser to authenticate a user or to pay for transactions.

Site Profiles 344 is a database defining attributes of sites. For example, Site Profiles 344 may store data that defines metamodules to execute when a user accesses a site and where the metamodules are stored, such as a URL that identifies a metamodule for a site and its location at the site.

### METABROWSER

Metabrowser 350 has numerous capabilities that are useful for projecting pages. Metabrowser 350 communicates over a network, such as Internet 302, with servers using the Hypertext Transport Protocol (HTTP). This capability allows metabrowser 350 to fetch HTML documents and VXML documents and submit the information to other servers that support HTTP, in a manner similar to the way conventional GUI browsers communicate with servers. To enhance performance, Metabrowser 350 may be configured to avoid fetching image data, such as files that contain data formatted according to the graphics interchange format (GIF). Metabrowser 350 is capable of securely communicating by using, for example, the Secure Sockets Protocol (developed by Netscape Communications Corporation), to communicate with sites. The metabrowser also handles cookies. Cookies are data stored on a client, such Metabrowser 350, by a server to preserve state information between HTTP requests transmitted by the client.

To project pages written in HTML, Metabrowser 350 is configured to comprehend pages that contain code and data that conforms to HTML. Metabrowser 350 parses code HTML pages, examining internal data structures and HTML user interface elements to generate objects that describe the internal data structures and user interface elements. The term user interface element refers to code and/or data that defines any item which may be presented to the user in a user interface or with which the user may interact. User interface elements may define links, forms, a text field in a form, a select box in the form, a table, a row in the table, a column, a text field, a heading, a select list field, an image data file (e.g GIF file), and a voice command. A user interface element may be referred to by the name of the type of element it describes. Thus the term “link” may refer to code defining a link in a page, the object or data used to instantiate the link at run time, or the display of the link in the GUI display of a browser.

When Metabrowser 350 parses a page containing HTML, it scans for tags in the page that demarcate user elements. For example, the Metabrowser 350 interprets the tag <a> to describe a link, <table> to describe a table, <tr> to define a row, <td> to define a row column, <option> to define values and value identifiers in an enumerated field, and <div>, <p>, and heading tags (e.g. <heading> and <hi>) to define text clips.

Typically, a user interface element is associated with functionality. Functionality refers to the operations that are performed in response to user interaction with a component defined by a user interface element. For example, functionality of a link includes accessing the resource identified by an attribute of the link. Functionality of a command button includes operations performed by methods invoked when the user manipulates the command button. The functionality of a text box includes collecting user input and storing a representation of it.

Metabrowser 350 is also capable of comprehending code that conforms to other computer language standards. For example, Metabrowser 350 can interpret code written according to the Javascript standard, promulgated by Netscape Corporation. Javascript is a scripting language that supports operations typically specified by high-level computer languages. Javascript may be executed dynamically on a browser. Often, it is used to program functions, which are executed dynamically on a browser to validate user input. Another language supported by Metabrowser 350 is the Extensible Markup Language (XML). XML is described in detail at ‘www.oasis-open.org/cover/xml.html#contents’ and at the sites listed therein. In general, the XML language includes tags that name fields and mark the beginnings and ends of fields, and values for those fields.

Metabrowser 350 also interprets pages containing code that defines voice-enabled interfaces, such as VXML. When Metabrowser 350 accesses a page containing VXML code, it does not examine the code to project an interface. Rather, Metabrowser 350 interprets the code, performing operations described according to VXML.

### USING A PARTICULAR METAMODULE

As mentioned before, Interfaces described by pages are projected through the execution of metamodules. Thus the interface projected depends on what metamodule is being executed by Metabrowser 350. There are a variety of circumstances and events that lead to executing a particular metamodule for a particular user, as follows.

A user from Users 307 may place a call via a phone network to a Phone server 310. A phone server 310 transmits a message to Metabrowser 350 to initiate a call session with Metabrowser 350. After the call session is initiated, a metamodule is selected for a user for subsequent execution.

During execution of a metamodule, Metabrowser 350 may encounter a preset in the form of a link to another metamodule in Metamodule Repository 340. This causes Metabrowser 350 to retrieve and execute the other metamodule for the user, as shall be described in greater detail. Alternately, the link may identify the URL of a metamodule stored at another site, such as Site 384, causing Metabrowser 350 to retrieve the metamodule from the site for subsequent execution.

Any time metabrowser 350 accesses a different site, it may examine Site Profiles 344 to determine whether Site Profiles 344 identifies any metamodules to execute when accessing the site. For example, a user may issue the Lingo command ‘World Wide Web’ to cause Metabrowser 350 to access a particular site. After loading the home page for the site, Metabrowser 350 examines Site Profiles 344 and determines that Site Profiles 344 identifies a metamodule to execute when a user accesses the site. Metabrowser 350 then retrieves the metamodule for subsequent execution.

### EXECUTING A METAMODULE

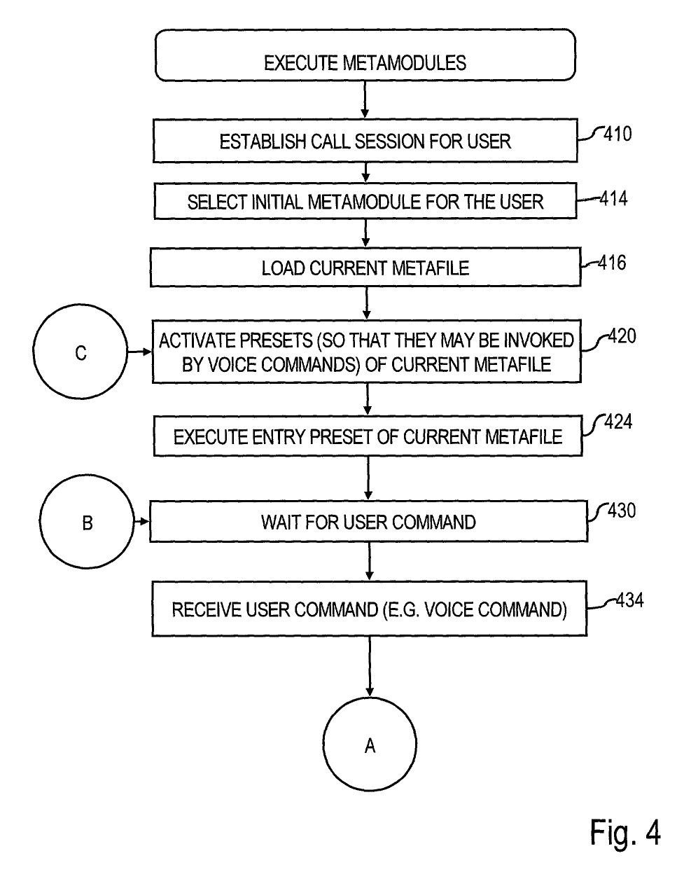

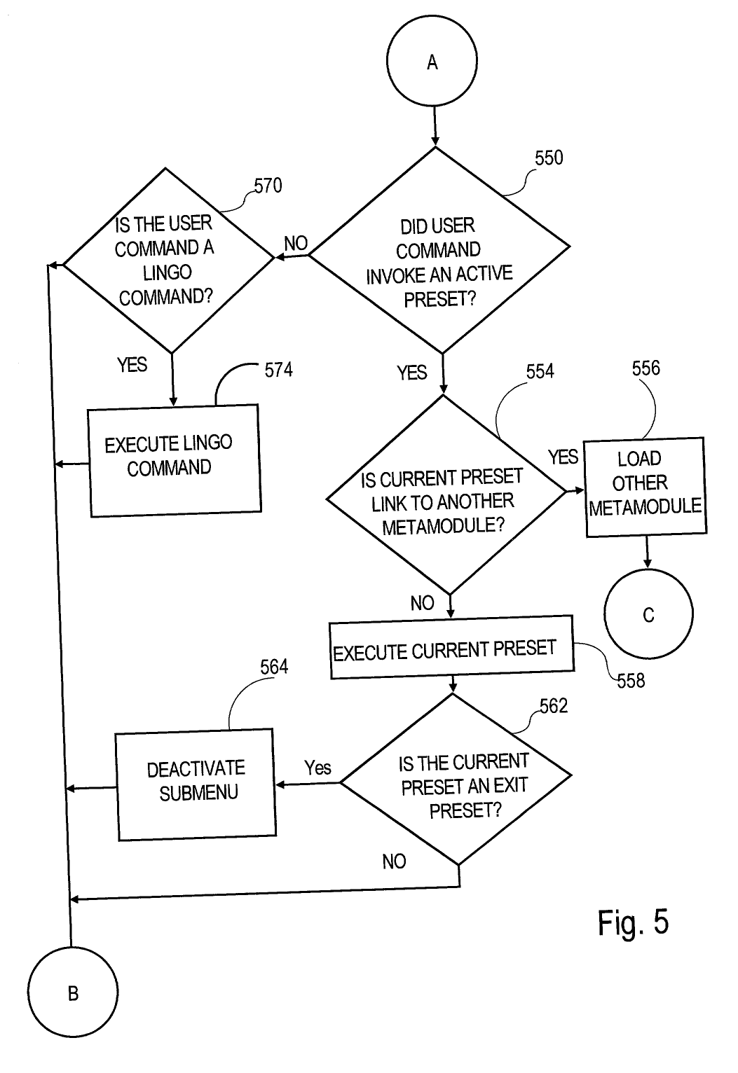

FIG. 4 and FIG. 5 are flow charts that depict processes that may be followed by Metabrowser 350 to execute metafiles and project an interface described by pages. The steps are illustrated using the exemplary architecture shown in FIG. 3. For purposes of illustrating an example, assume that a user from Users 307 has called via a phone network to phone server 310. In response, Phone server 310 has transmitted a message to Metabrowser 350 to initiate a call session with Metabrowser 350. The message includes information identifying the user, information such as a phone number of the user, or an account number for the user previously established by the operator of the phone network.

Referring to FIG. 4, Metabrowser 350 receives the message to establish the call session. At step 410, Metabrowser 350 establishes a call session with the user, assigning resources to process the call, such as a process or a thread and memory space. Once a call is issued, user commands are issued by Phone server 310 to Metabrowser 350 in response to a User 307 issuing commands through the phone network.

At step 414, Metabrowser 350 selects an initial metamodule to execute for the user. This step may be performed in a variety of ways. For example, the Metabrowser 350 may access User Profiles 342 to examine user information associated with the phone number of the user. Such information may specify a metamodule for the user, or may specify other information used to look-up the initial metafile. The user information may specify a user group with which the user is associated. User profiles 342 may contain a mapping between user groups and initial metamodules. To determine the initial metamodule for a group, Metabrowser 350 may access the mapping to examine it. The metamodule, once selected, becomes the current module.

At step 416, the current metamodule is loaded into memory in preparation for execution.

At step 420, the body presets are activated. This step may include activating the presets by generating a list of body presets that lie outside the scope of any submenu module. Each entry in the list corresponds to a body preset and may include data specifying the preset identifier for the preset, which is the voice command for the preset, and a flag indicating whether the preset is active.

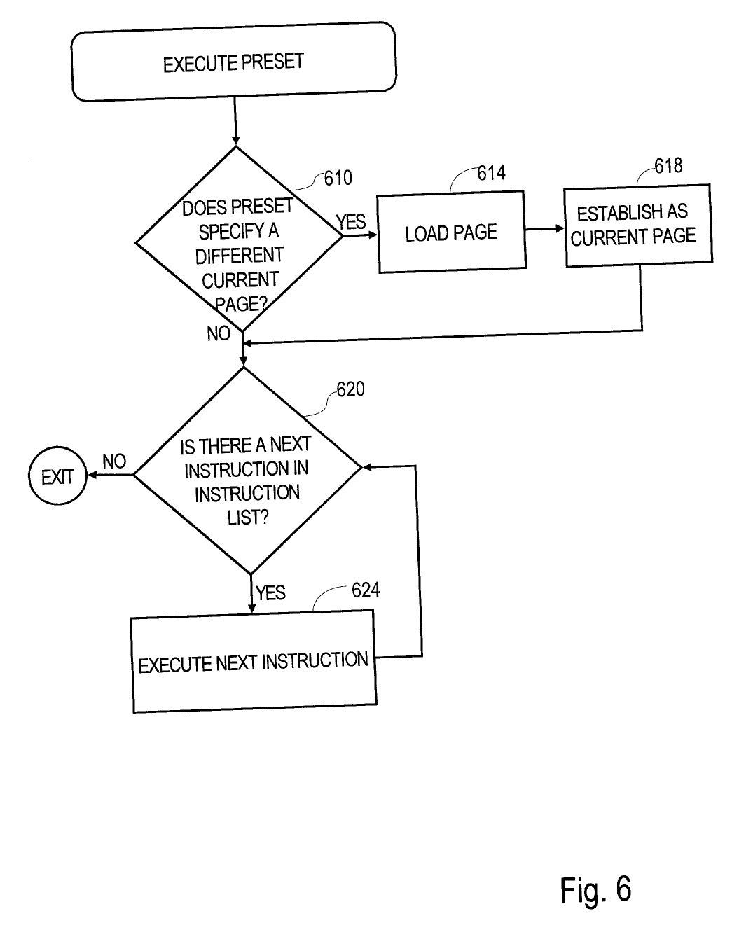

At step 424, the entry preset defined for the metamodule is executed. The entry preset is executed according to a process which is depicted in FIG. 6, which shall be later described.

At step 430, the Metabrowser 350 waits for a user command from Phone server 310. At step 434, Metabrowser 350 receives a user command from Phone server 310.

Referring to FIG. 5, at step 550, Metabrowser 350 determines whether the user command is associated with an active preset. This determination may be made by examining the list of presets generated at step 424 to determine whether the user command specifies a user command associated with an active preset. If the user command specifies a user command that is associated with an active present, then control flows to step 554, where the preset is processed as the current preset.

If the user command specifies a user command that is not associated with an active preset, control flows to step 570. At step 570, it is determined whether the user command specifies a Lingo command. If the user command specifies a Lingo command, then at step 574, the voice command is executed as an instruction containing a Lingo command. A Lingo instruction may cause another page to be loaded. For example, the instruction “click back” will cause the previous page to be reloaded by Metabrowser 350. When a Lingo instruction causes another page to be loaded, that page becomes the current page.

At step 554, it is determined whether the current preset is a link to another Metamodule. A link to another Metamodule has the format specified in Table A. An example of a link to another Metamodule is ‘@Check News; Mynews’. This string specifies a preset identifier having the value ‘Check News’, and also specifies that the linked Metamodule is ‘Mynews’. If it is determined that the current preset is a link to another metamodule, then at step 556, the other metamodule is loaded in a manner similar to that described for step 416 in FIG. 4. The other metamodule becomes the current metamodule, and control then flows to step 420. If it is determined that the current preset is not a link to another metamodule, then control flows to step 556.

At step 558, the current preset is executed according to the process depicted in FIG. 6, which shall be later described.

At step 562, it is determined whether the current preset is an exit preset of a submenu module. If the current preset is the exit preset of a submenu module, then at step 464 the body presets for the submenu module are deactivated. Control then returns to step 430, where the metabrowser awaits for another user command.

### EXECUTING A PRESET

FIG. 6 shows the process followed by Metabrowser 350 to execute a preset. Referring to FIG. 6, at step 610, it is determined whether the current preset specifies a different page then the current page. If the macro block of the current preset specifies a URL, and the URL identifies a page different then the current page, then the current preset specifies a different current page. Control then flows to step 614.

At step 614, the page is loaded. As mentioned before, Metabrowser 350 parses pages to examine internal data structures and code defining user interface elements, and generates objects that describe the internal data structures and user interface elements. Metabrowser 350 uses the objects when executing metacode instructions. For example, a page defines tables, rows for each table, and text for each of the rows. During execution of this step, Metabrowser 350 generates objects that describe the tables, rows, and text for each of the rows. When Metabrowser 350 executes an instruction containing the ranc command, Metabrowser 350 examines these objects.

At step 618, the loaded page is established as the current page. Control flows to step 620.

Steps 620 to 624 define a loop in which each instruction of the instruction-list for the current preset is executed. When executing the loop, the instructions in the instruction-list are executed sequentially, from top to bottom. At step 620, it is determined whether there is a next instruction in the current preset. When execution of the loop is initiated for a current preset, the next instruction is the first instruction, if any. If there is no next instruction, execution of the steps shown in FIG. 6 ceases. Otherwise execution proceeds to step 624.

At step 624, the instruction is executed, and then control returns to step 620. Execution of an instruction can cause a new page to be loaded. When this occurs, the loaded page becomes the current page.

### INSTRUCTION LIST AND BEHAVIOR

Metalanguage Summary Table B describes metacode language commands according to an embodiment of the present invention. Metalanguage Summary Table B lists commands, and for each command, a summary of the operations performed for the command. Appendix A includes a list of commands and a description of the operations that is more comprehensive than Table B.

METALANGUAGE SUMMARY TABLE B

| Metalanguage Command | Summary |
|---|---|
| Link Related commands to | |
| process links in a page. | |
| CheckLinks | Loads top 5 links into the active link set |
| NextLink \| Next | Loads next 5 links into the active link set |
| Lanc {<string>, } | Points active link cursor to link containing specified |
| | strings to affect where CheckLinks, Next, NextLink |
| | search for links. |
| Click <1>1<2>1<3>1<4>1<5> | Activates the link containing <string> or identified by |
| \|<String> | its position in the active set. |
| Clink <col>\|<col><?> | Activates or tests for a link in the specified column of |
| | the current row. The test is accessible by the SOS and |
| | SOF commands. |
| Text Related Commands to | |
| extract, prepare & output text | |
| Playclip | Add first text clip of current page to audio output buffer |
| NextClip\|Next | Add next text clip to audio output buffer. |
| ClipSize <10>\|<20> | Sets minimum size of text clip resulting from execution |
| | of Playclip, NextClip, or Next |
| Replace {<string> | Replace string in audio output buffer with another string |
| <string>\|<<fn>“.wav”,} | or a way file |
| TTS\|TEXT | Output text or audio output buffer |
| Tanc <string> | Add text clip with <string> to output buffer |
| Way <fn>[string] | Way audio file output function call |
| Table Related commands locate | |
| and extract table info | |
| Ranc {<string>, } | Add text of row containing specified strings to output |
| | buffer |
| NextRow | Current row = next row |
| Columns {<string><col>,} | Add text of columns specified by <col> in current row |
| | containing <string>. |
| PreviousRow | Current row = previous row |
| Metrow {<string>, } | Add to audio output buffer text contained in the rows |
| | starting with the current row to the row containing |
| | specified strings. |
| Forms Related commands take | |
| input and submit for processing. | |
| Get <str>\|<@<fn>“.wav”> | Prompts the user with <string> or WAV audio, |
| [<@<fn.txt>>] | optionally selects from fn.txt and fills in the input field |
| <string> | specified by <string>. |
| Set <value><string> | Sets the value of a page defined field to the value of |
| | <stnng>. |
| GetNum <len><string> | Prompts the user with <string> or way audio file for |
| \|<@<fn>“.wav”><string> | <len> number of key pad digits and fills in field |
| | identified by <search string>. |
| Submit <string> | Submits form identified by <string> over HTTP. |
| Portal Related navigation | |
| independent of web pages. | |
| Menu | Outputs the entries of the current preset menu level. |
| BackUp | Resets the current preset menu to previous preset menu |
| | in preset menu hierarchy. |
| BackTrack | Resets the page to previous web page and also resets the |
| | current preset menu if necessary. |

### PERSONAL COMPUTER ARCHITECTURE

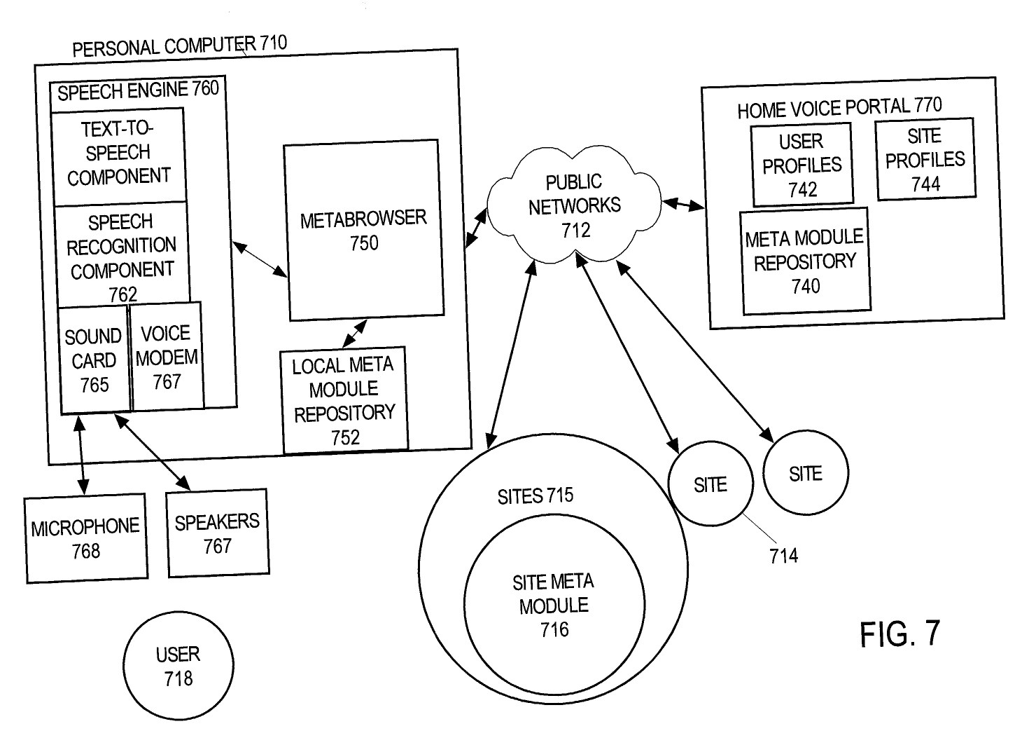

FIG. 7 is a block diagram that shows a system architecture of an embodiment that may be implemented using a personal computer. Referring to FIG. 7, Personal Computer 710 is coupled to a Public Network 712, such as the Internet. Personal computer 710 may coupled to Public Network 712 via an Internet Service Provider. Sites 714 are coupled to Public Network 712, through which Sites 714 may be accessed by Personal Computer 710.

Personal Computer 710 includes a Metabrowser 750 to allow User 718 to interact through projected interfaces with resources accessible via Public Network 712. Speech Engine 760 provides to Metabrowser 750 services similar to those that Phone Server 310 provides to Metabrowser 350. These services include (1) converting speech received from the user into user input strings for Metabrowser 750, and (2) receiving user audio output to play back to the user in audio. To enable it to provide these services, Speech Engine 760 includes a variety of software and hardware. These include Sound Card 765, to which are coupled Microphone 768 and Speakers 764, Text-to-Speech component 761, and Speech Recognition Engine 762.

Metabrowser 750 operates similarly to Metabrowser 350. Metabrowser 750, however, is configured to retrieve metamodules from Home Voice Portal 770. Home Voice Portal 770 includes Metamodule Repository 340. Once a metamodule is downloaded, it may be cached for later access on Personal Computer 710 in, for example, a disk cache. Metabrowser 750 may also retrieve metamodules stored in Local Metamodule Repository 752. Local Metamodule Repository 752 may also be used to cache metamodules downloaded from Metamodule Repository 340.

The metamodules stored in Local Metamodule Repository 752 may be specifically customized for the user, and in fact, may be created by the user using standard text editor utilities. Alternatively, the metamodules may be developed using user applications, software development applications specifically configured to facilitate implementation of metamodules written in metacode.

Home Voice Portal 770 also includes User Profiles 742, and Site Profiles 344. User Profiles 742 and Site Profiles 344 hold information similar to that held by User Profiles 342 and Site Profiles 344.

When User 718 launches Metabrowser 750, Metabrowser 750 transmits a message to Home Voice Portal 770 requesting an initial metamodule for User 718. The message includes information identifying the User 718. When the Home Voice Portal 770 receives the message, it uses the identifying information to determine whether User Profiles 742 specifies any initial metamodule for the user, in a manner similar to that described previously for Metabrowser 350. If an initial metamodule is specified for the User 718, Home Voice Portal 770 transmits the metamodule to Metabrowser 750. Metabrowser 750 then executes the metamodule, retrieving metamodules as needed from Home Voice Portal 770 and Local Metamodule Repository 752.

In an embodiment, Speech Engine 760 may also be configured to receive input through Voice Modem 767. This allows a user to access Metabrowser 750 by calling Voice Modem 767 to issue voice commands. To access the public network expeditiously, and without need for an additional voice modem, Personal Computer 710 is preferably connected to a public network via a persistent broadband connection, such as a digital subscriber line. Access to Metabrowser 750 via a phone modem may allow access to customized metamodules stored locally in Metamodule Repository 757. Accessing them in this manner may eliminate the need to replicate customized metamodules in other repositories, or the need to permit access to Local Metamodule Repository 752 by telephone portals.

### OTHER EMBODIMENTS

The present invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

As mentioned before, the techniques described herein for projecting interfaces are illustrated by describing techniques that audio enable adapted interfaces. However, interfaces may be projected in other ways that use modalities of interaction other than audio modalities. For example, interfaces may be projected to allow handicapped persons, with little ability to control their hands, to access projected interfaces with devices specially designed for handicap persons. The metamodules associate presets with commands that could be issued through the specially designed devices.

Alternatively, a projected interface that provides access through modalities of interaction other than the audio modality, may be generated for mobile devices connected to wireless networks. For example, projected interfaces may be developed for mobile devices configured for the Wireless Application Protocol (WAP). WAP was developed for mobile devices that have limited computing capacity as compared to personal computers, mobile devices with less memory, processing, and graphics capabilities than personal computers. To accommodate the more limited capabilities of such mobile devices, WAP capable devices may run microbrowsers. Microbrowsers download smaller file sizes to accommodate the low memory constraints of handheld mobile devices and the low-bandwidth constraints of wireless networks. Microbrowsers are capable of interpreting code that conforms to the WML language (a dialect of XML). WML is designed for small screens and one-hand navigation without a keyboard, which is useful for handheld mobile devices. Microbrowsers interpreting WML may generate user interfaces for a range of displays, from two-line text displays to graphic screens found on handheld mobile devices such as smart phones and communicators. WAP also defines a computer language referred to as WMLScript. This language is similar to JavaScript, but demands minimal memory and processing power because WMLScript does not contain many of the functions found in other scripting languages.

WAP is promulgated by the WAP Forum, which has issued many specifications that define various aspects of WAP. Such specifications are listed in Appendix C; each specification cited in Appendix C is herein incorporated by reference.

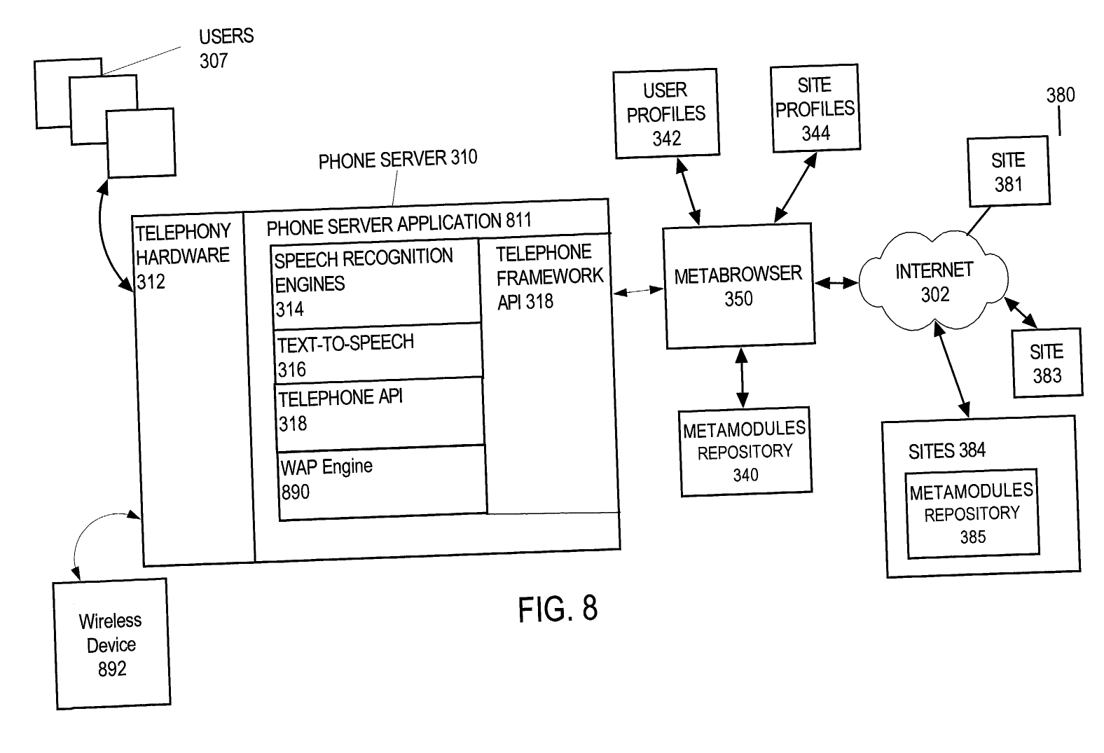

FIG. 8 shows a system architecture that includes components that participate to project interfaces for WAP capable devices. Referring FIG. 8, it shows many of the components described in FIG. 3, with the following differences. FIG. 8 shows Phone Server Application 811, which provides many of same services to Metabrowser 350 provided by Phone Server Application 311. In addition, Phone Server Application 811 provides services that allow Metabrowser 350 to interact with users through interfaces generated for WAP capable devices, such as Wireless Device 892. To provide such services, phone server application uses WAP Engine 890.

A WAP engine is a combination of hardware and software that translates WAP compliant input into user commands recognized by Metabrowser 350, and translates output generated by Metabrowser 350 into a WAP compliant form. For example, when voice commands are activated, not only is the vocabulary of Speech Recognition Engine 314 extended with voice commands, but the voice commands are used to generate WML code (and/or WMLScript) defining an interface. The code defines a list of menu items to display that correspond to the voice commands. Once the code is transmitted to Wireless Device 892, it generates a display of the list of menu items. The menu items may be selected by the user by depressing keys on the device. When a menu item is selected in this way, Wireless Device 892 transmits data specifying the selection, which is eventually received by WAP Engine 890 and translated into a corresponding user command, for subsequent communication to Metabrowser 350.

If the wireless device is capable of transmitting audio data, a user may select a displayed menu item by simply speaking the voice command corresponding to the menu item. Using WAP capable devices in this manner offers the advantage of communicating a selection of menu items using a visual oriented modality of interaction, and allowing access to the menu items using an audio modality of interaction. In an alternate embodiment, a phone application server may be configured to only support WAP compliant communication.

### HARDWARE OVERVIEW

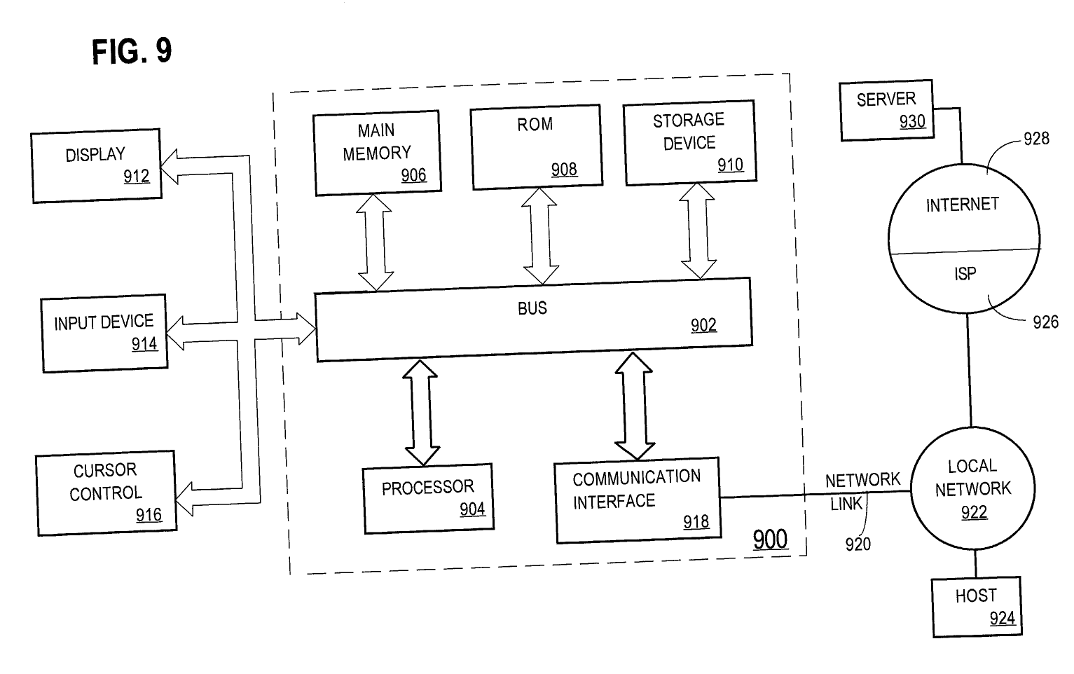

FIG. 9 is a block diagram that illustrates a computer system 900 upon which an embodiment of the invention may be implemented. Computer system 900 includes a bus 908 or other communication mechanism for communicating information, and a processor 904 coupled with bus 908 for processing information. Computer system 900 also includes a main memory 906, such as a random access memory (RAM) or other dynamic storage device, coupled to bus 908 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 908 for storing static information and instructions for processor 904. A storage device 910, such as a magnetic disk or optical disk, is provided and coupled to bus 908 for storing information and instructions.

Computer system 900 may be coupled via bus 908 to a display 912, such as a cathode ray tube (CRT), for displaying information to a computer user. An input device 914, including alphanumeric and other keys, is coupled to bus 908 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

The invention is related to the use of computer system 900 for implementing the techniques described herein. According to one embodiment of the invention, those techniques are performed by computer system 900 in response to processor 904 executing one or more sequences of one or more instructions contained in main memory 906. Such instructions may be read into main memory 906 from another computer-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 908. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 908. Bus 908 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 908. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution. In this manner, computer system 900 may obtain application code in the form of a carrier wave.

### APPENDIX A

### MetaCode Commands

Creating Variables Dynamically

Save a [v1 ,v2, . . . ], where a:=<variable>, v1:=<value>, and v2:=<value>This command causes the metabrowser to store values in the variable specified by a. The variable is used to store values specified by v1, v2, v3.. For example, ‘Save CurrentMovie &cmovie :Action’ creates a variable Currentmovie with the string value “Lethal Weapon 2:Action”. The &cmovie is a variable having the value “Lethal Weapon 2”. Variables are later referenced by prefixing them with an ‘&’. If no values are specified, then the value stored is the value of the most recent text clip added to the audio output buffer.

Link Related Commands To Process Links In A Page

Lanc s, where s:={string,}—The Lanc command causes a “link cursor” to point to a link defined in a page that contains the strings specified by s. A cursor is a stored value used to specify the location of an item, such as a link, or a row. For example, the instruction ‘Lanc “More new releases”’ sets the link cursor to a link that precedes a group of links that correspond to a group of movies, thereby allowing the links to be extracted by subsequent link extraction commands. Other link extraction commands, such as CheckLinks and NextLink, operate relative to the link cursor.

CheckLinks—Checklinks command causes the first five links to be added to the “active set”. The first five links are the first five links after the link cursor, or if the link cursor has net been set after loading a page, the first five links defined by the page. A link in the active set may be navigated to using, for example, the Click command or Next command. When a link is added to the active set, text for the link is added to the audio output buffer. For example, Lanc Movie Releases! CheckLinks!text causes generation of user audio output describing the first five new movies as user audio output.

NextLink—The NextLink command works like the Checklinks command, except that it adds links beginning from a position after the active set for a page, or if none, from the first link. Specifically, Nextlink adds the next five links to the active set beginning after the last link of the current active set.

Click n, where n:=<1>|<2>|<3>|<4>|<5>| <String>. Click n causes the metabrowser to access the resource referenced by the link identified by n from the active set, if any. Specifically, Click <string> causes the metabrowser to search for a link in the active set containing <string> in the current page and causes the page to be downloaded as the current page. For example, click “Boys don't cry” loads the page specified by the link in the active set containing the string “Boys don't cry”. Click <1>|<2>|<3>|<4>|<5>, which specifies a position in the active set, causes the metabrowser to download the resource referenced by the link corresponding to the position. For example, the instruction ‘lanc “More new releases”!checklinks!click 2’ causes the metabrowser to download the page referenced by the second movie link in the active set.

Clink c, where c:=<column>. Clink c causes the metabrowser to access the resource referenced by the link in the column specified by c in the current row. The current row is the row referenced by the row cursor. The row cursor is set by such commands as Ranc, NextRow, PreviousRow, and Metrow. For example, in the instruction ‘clinc 3’, ‘3’ identifies the third column in the current row, which contains a link. The instruction causes the metabrowser to download the page referenced by the link.

Text Related Commands To Extract, Prepare & Output Text

ClipSize n, where n:=<number>. The ClipSize command the default length criteria for a text clip to be extracted from the pages by text extraction commands. For example, setting “ClipSize 20” will allow for finding text blocks of at least 20 words (a, the, an, etc. are not counted). Clipsize is useful for news oriented pages, which organize textual information as text blocks.

Playclip—The Playclip command causes extraction of the first text clip, from the top of the page, that has at least the size specified by the ClipSize command, and places the extracted text in the audio output buffer. For example, ‘click “Hot New Release”!clipsize 20!PlayClip!text’ loads a page containing the latest movies and extracts text that describes the movies. The ‘text clip cursor’ is set to point the location of the text clip from which the text is extracted.

Nextclip The Nextclip command causes the metabrowser to extract the next text clip, relative to text clip cursor, that has at least the size specified by ClipSize. The extracted text is placed in the audio output buffer. The current text clip cursor is set to point to the next text block. For example, “News!clipsize 20!PlayClip!NextClip!text” loads the page containing the latest news and extracts the second text clip, which contains the second news item in the latest news.

Tanc s where s:==<string>. The Tanc s command causes the metabrowser to locate the text clip containing the string s, extract the text contained in the block and add the extracted text to the audio output buffer. The text block cursor is set to point to the located text block. For example, ‘Tanc Welcome’ finds the text clip containing the string ‘Welcome back Adam to Your sports information page’.

Table Related Commands To Locate And Extract Table Info

Ranc s, where s:={<string>,} Ranc s locates the next table row that contains the string values specified by s. The search begins from the row pointed to by a cursor referred to as the row cursor, or if the row cursor has not been set for a page, the search begins with the first row. If a row is located, then the text of the entire row is added to the audio output buffer. For example, the instruction ‘Ranc Balance’ will cause the metabrowser to locate the table row containing “Balance” and add the entire text of the row to the audio output buffer.

NextRow NextRow locates the next table row, beginning with the row pointed to by a cursor referred to as the row cursor, or if the row cursor has not been set for a page, beginning with the first row. NextRow sets the row cursor to the next row, and loads the text contained therein into the audio output buffer.

PreviousRow PreviousRow locates the previous table row, beginning with the row pointed to by a cursor referred to as the row cursor. If the row cursor has not been set for a page, then there is no previous row. PreviousRow sets the row cursor to the next row, and loads the text contained therein into the audio output buffer.

MetRow t, where t {<string>,} MetRow t gathers all the text contained in the rows, starting with the row pointed to by the row cursor, or the first row if the row cursor has not been set for the page, ending with the row containing the strings specified by row t. The text is added to the audio output buffer.

Columns {s, c, . . . } where s:=string> and c :=<column>. This command causes preparation of the current row for output by extracting text from the columns specified by c and prefixing them with the string value specified by s. For example, a row has columns 1, 2, and 3 with values ‘Panasonic DVD Player 5650’, ‘335 dollars and 99 cents’, ‘Mar. 14, 2001’, respectively. The instruction ‘Column ¢Product” 1 “with a price of’ 2 37 will be shipped on” 3’ adds the following text to the audio output buffer: ‘Product Panasonic DVD Player 5650 with a price of 335 dollars and 99 cents will be shipped on Mar. 14, 2001.’

Forms Related Commands Take Input And Submit For Processing.

The following commands are used to process forms and their fields. Forms, fields, and field values are specified using standards specified for HTML and HTTP, as illustrated below.

Set v id, where v:=<value> and id :=<string>. The Set command causes the metabrowser to set the field specified in operand id to the value of v in the form identified by the field id. For example, the instruction ‘Set &mycity Name=city’ causes setting the value of the form field with the name ‘city’ to the value in variable &mycity.

GET p id [fname], where p:=<str>|<@<fn>“.wav”>|[<@<fn.txt>>]<string>. The Get command causes the metabrowser to play the prompt specified by p. The parameter P may specify a string or a wav file. The metabrowser receives a user input string and stores the string for subsequent submission. The string is submitted as a value for the form field identified by id. The strings may be a series of letters spelling words values for the field.

HTML code in a page may define a form field as an enumerated field, and specify a mapping between value identifiers and values. For example, a <select> tag defines a field in a form. Value identifiers, values, and a mapping of them, are defined by <option> tags. The value identifier ‘California” is mapped to ‘CA’, and the value ‘Pennsylvania’ is mapped to ‘PA’. When executing an instruction containing the Get command, the metabrowser receives as user input a value identifier for an enumerated field and stores the value mapped to the value identifier for subsequent submission.

Receipt of a Menu command while executing the Get command causes the metabrowser to output as user audio output the value identifiers for the enumerated field. The Get command also sets the input variable &INPUT to the value the user provided for subsequent processing.

The operator fname may be used to specify a file name that contains text specifying a list of values for a field. Receipt of the Menu command causes the metabrowser to generate user audio output of the list of values. Also, the metabrowser activates the list of values, allowing a user to convey input using spoken words rather than spelled words. This feature is useful for user customization because fname may be used to refer to a file that contains a list of values that have been customized for the user. For example, user profiles 342 contains a list of addresses used by a user, such as the user's home address, work address, and shipping address. The Get command may be used to get information for a “City field” for an address. A file may be generated containing all cities in all the addresses used by the user.

Submit id, where id:=<string>. Causes submission to a site of the form field values specified for the form identified by id. In response to submitting the form field values to a site, the site transmits another page to the metabrowser, which becomes the current page.

GetNum n p id, where n:=<number>, p:=<<string>|<@<fn>“.wav”>>, and id:=<string>. The GetNum command causes the metabrowser to collect from the user n number of DTMF digits for the form field identified by id, after an audio prompting of the user according to the string or digital audio file specified by p.

Prompt s, where s:=<<string>|<@<fn>“.wav”>>. This command allows definition of a secondary prompt that may be used when a user fails to provide appropriate user input. The user may provide user input that is not appropriate in a variety of ways. For example, a user may fail to respond after a period of time, may provide an unrecognized user command (e.g. depress a key pad on a phone with no corresponding preset), or may provide user input that does not correspond to a value identifier when providing input for an enumerated field. If no secondary prompt is specified, then the user is prompted with a default secondary prompt, such as “I am sorry I did not get your input”. The Prompt command allows for more useful secondary prompts. For example, “Please provide your Reservation number” may be more useful than “I am sorry I did not get your input”.

Next and Previous Command

Next—The Next command depends on the most previous execution of an instruction that includes either the Search command, or any command that sets the row cursor, table cursor, or text clip cursor. The most previously executed Command from this set dictates how the Next command behaves. For example, if the most previously executed command includes NextRow, PreviousRow, or Ranc s, then the Next command causes the row cursor to point to the next row. If the most previously executed command from this set of commands includes Lanc, NextLink, or Click, then the Next command causes the link cursor to point to the next link. If the most previously executed command from this set of commands includes Tanc, NextClip, or PlayClip, then the Next command causes the text cursor to point to the next text clip. If the most previously executed command from this set of commands is Search, then the Next command causes the metabrowser to output as user audio output the next found search result.

Previous—Like the Next command, the Previous command depends on the most previous execution of an instruction that includes either the Search command, or any command that sets the row cursor, table cursor, or text cursor. However, the Previous command causes the cursor to point the previous item. For example, if the most previously executed command from this set of commands is either NextRow, PreviousRow, or Ranc s, then the Previous command causes the row cursor to point to the row before the current row.

Voice Enabling Customized Pages

Mask—The Mask command causes the metabrowser to deactivate a preset, preventing a user from invoking the preset by, for example, issuing a voice command associated with the preset. This command, when combined with commands that set cursors and control execution flow, facilitates projected interfaces that project pages that are customized users. For example, the Yahoo site, operated by Yahoo Incorporated, allow user options for controlling the content of pages for users. A link for sports news is generated for some users but not for others, according to options selected by the users. A metamodule for the users who access the Yahoo site may contain presets that account for any content that may be generated for a page, including a preset for sports news. The presets may be selectively “masked” according to the content of the interface actually generated for a user. Thus a preset for sports news may be masked for some users but not for others. This enables development of a metamodule that is able to accurately project a wide range of adapted interfaces.

Reformatting System Text Data In An Audio Output Buffer

Replace {s, v, . . . }, where s:=<string> and v:={<string>|<@<file name>‘.wav’>} The Replace command causes the metabrowser to search for the string specified by s and 20 replace it in the audio output buffer with the value specified by v, if found. The metabrowser repeats this operation for every pair of s and v operands. The value specified may be a wav file, such as filename.wav, or a string value. For example, Replace “today's movie” @todaymovie.wav produces user audio output of “Today's Movie is” followed by a playback of the digital audio recording in file todaymovie.wav.

Using Conditional executing and branching in meta files

SOS n, where n:=<number>. This command is used for conditional branching. SOS causes the metabrowser to skip the next n instructions if execution of the previous instruction was successful. Examples of successful execution of instructions include: (1) locating a row by executing ‘ranc s’, and (2) setting the row cursor to point to the next row by executing ‘Nextrow’.

SOF n, where n:<number>. This command is used for conditional branching. SOF causes the metabrowser to skip the next n instructions if execution of the previous instruction was unsuccessful. Examples of unsuccessful execution of instructions include: (1) failure to locate a row by executing ‘ranc s’, and (2) failure to set the row cursor to point to the next row by executing ‘Nextrow’.

If Then, Else A construct used for conditional logic. Its execution depends on the success or failure of a previously executed instruction.

Manipulating String Values

SPLIT &v p I r, where:=<variable>, p:=<string>, l:=<variable>, r:<variable> The Split command causes splitting the string value in variable v into two other values, starting where the string value specified by p starts in v. The two other values are stored in l and r.

Outputting Text and Files Containing Digital Audio Data

Wav f [s] b, where f:=<file name> and :s=<string>. The Wav command adds the file specified by f to the output buffer. If the file cannot be found, the string specified by s, if any, is added to the audio output buffer. The command is considered to have completed successfully if the file is added to the output buffer. The sos command may be used to cause execution of instructions in case the file specified by s is not found. For example, ‘Wav &movie _{—!SOS} 2 !playclip!text’ causes the metabrowser 350 to see whether the selected file exists. If it does, the file is played; otherwise the text found by execution of play clip is output.

TTS s where s:=<string>. The TTS commands causes generation of user audio output based on the string value specified by s. For example, the instruction ‘TTS Today's weather is &tweather’ produces audio output of the phrase “Today's weather is Sunny”. The variable &tweather holds the value ‘Sunny’.

TTSb s where s:=<string>. TTSb command evaluates all values specified the operand s and puts the resulting value in the audio output buffer.

Using Java in Meta files

JS “{”<JavaScript>“}” This command allows for execution of Java Script code contained in a metamodule. Variables defined via the Save command can be referenced and operated upon by the JavaScript code. The function return value is added to the audio output buffer, where the value may be further processed using Replace & Save commands.

### APPENDIX B

Lingo

Backup—This command causes the deactivation of the current menu and its associated presets.

CheckUrl—Causes the metabrowser to output to the user audio output text describing the URL of the current page.

Echo—Toggles echo mode on and off. If Echo mode is on, voice commands recognized by the metabrowser are output to the user as received.

Find—Asks the user to spell the keyword to find in the current page. It looks for the first link containing this keyword. Returns the text of a link as well as its associated URL the text.

Lingo—Outputs the available lingo commands.

MainMenu—Activates the top level preset menu level and deactivates any activated submenus.

HomeMenu—Activates the top level preset menu level and deactivates any activated submenus.

LastPage—The metabrowser keeps a history log of the pages accessed by it, similar to the history log maintained by conventional GUI browsers. LastPage causes the metabrowser to load the page previous to current page in the history log.

NextPage—Next page causes the metabrowser to load the next page after the current page in the history log, if any. The current page is then set to the loaded page.

NoEcho—Set Echo mode off. See Echo.

Reload—Causes the metabrowser to reload the current metamodule and to execute the entry preset, and sets the current preset menu level to the top preset menu level.

Search—This command is used to search a string on the World Wide Web using a search engine, such as GO2NET, which may be accessed at ‘search.go2net.com/crawler’. In response to receiving this audio user command, the user is prompted to spell a string. When the spelled input is received, the search is executed. When the metabrowser receives the results, it forms a list of all the search items and returns the first item.

Verbose—Causes the metabrowser to toggle a verbose mode on and off. While the verbose mode is on, whenever a new site is accessed, the metabrowser generates user audio output identifying the site.

World Wide Web—Asks the user to spell a URL, and then access the resource identified by the URL.

CheckLinks—See Appendix A.

NextClip—See Appendix A.

NextLink—See Appendix A.

PageTitle—Returns the title for the current page, i.e. the contents between the <title> and </title> tags.

PlayClip—See Appendix A.

### APPENDIX C

WAP-100, Wireless Application Protocol Architecture Specification, Apr. 30, 1998

WAP-195, Wireless Application Environment Overview, Mar. 29, 2000

WAP-190, Wireless Application Environment Specification, Mar. 29, 2000

WAP-191, Wireless Markup Language Specification, Feb. 19, 2000

WAP-192, Binary XML Content Format Specification, May 15, 2000

WAP-193, WMLScript Language Specification, June 2000

WAP-194, WMLScript Standard Libraries Specification, June 2000

WAP-120, WAP Caching Model Specification, Feb. 11, 1999

WAP-175, WAP Cache Operation Specification, Dec. 6, 1999

WAP-174, User Agent Profiling Specification, Nov. 10, 1999

WAP-174.100, User Agent Profiling Specification SIN, Jun. 21, 2000

WAP-165, Push Architectural Overview, Nov. 8, 1999

WAP-151, Push Proxy Gateway Service Specification, Aug. 16, 1999

WAP-151.100, Push Proxy Gateway Service Specification SIN, Feb. 18, 2000

WAP-145, Push Message Specification, Aug. 16, 1999

WAP-189, Push OTA Protocol Specification, Feb. 17, 2000

WAP-167, WAP Service Indication Specification, Nov. 8, 1999

WAP-168, WAP Service Loading Specification, Nov. 8, 1999

WAP-164, Push Access Protocol Specification, Nov. 8, 1999

WAP-164.100, Push Access Protocol Specification SIN, Feb. 18, 2000

WAP-203, Wireless Session Protocol Specification, May 4, 2000

WAP-203.001, Wireless Session Protocol Specification SIN, Jun. 20, 2000

WAP-201, Wireless Transaction Protocol Specification, Feb. 19, 2000

WAP-200, Wireless Datagram Protocol Specification, Feb. 19, 2000

WAP-204, WAP over GSM USSD Specification, May 23, 2000

WAP-202, Wireless Control Message Protocol Specification, Feb. 19, 2000

WAP-159, WDP/WCMP Wireless Data Gateway Adaptation, Nov. 5, 1999

WAP-199, Wireless Transport Layer Security Specification, Feb. 18, 2000

WAP-198, Wireless Identity Module, Feb. 18, 2000

WAP-161, WMLScript Crypto API Library, Nov. 5, 1999

WAP-169, Wireless Telephony Application Specification, Jul. 7, 2000

WAP-170, Wireless Telephony Application Interface Specification, Jul. 7, 2000

WAP-171, Wireless Telephony Application Interface Specification, GSM Specific Addendum, Jul. 7, 2000

WAP-172, Wireless Telephony Application Interface Specification, IS-136 Specific Addendum, Jul. 7, 2000

WAP-173, Wireless Telephony Application Interface Specification, PDC Specific Addendum, Jul. 28, 2000

WAP-188, General Formats, Aug. 15, 2000

What is claimed is:

1. A method for enabling access to an interface, the method comprising the steps of:
receiving a first description of a user interface that is written in a first computer language and that describes one or more user interface elements;
receiving a second description written in a second computer language that describes one or more user commands and one or more instructions associated with each user command of said one or more user commands;
receiving a user command of said one or more user commands;
in response to receiving said user command, executing at least one instruction of the one or more instructions associated with said user command; and
wherein executing at least one instruction of the one or more instructions causes accessing functionality associated with at least one user interface element described by said first description.

2. The method of claim 1, wherein said user command is a user command conveyed audibly by a user.

3. The method of claim 1, where said user command is a user command conveyed through a phone.

4. The method of claim 1, wherein said user command is received using a modality of interaction that, according to said first computer language, is not defined by said first description for said at least one user interface element.

5. The method of claim 4, wherein said modality of interaction is an audio modality of interaction.

6. The method of claim 1, wherein the step of executing at least one instruction includes executing a particular instruction that includes a particular command for processing items of text defined by said first description according to said first computer language.

7. The method of claim 6, wherein the step of executing said particular instruction causes setting a value that indicates the location of an item of text in said first description that contains one or more strings.

8. The method of claim 7, wherein said particular instruction includes one or more parameters that specify one or more values of said one or more strings.

9. The method of claim 6, wherein the step of executing said particular instruction causes locating an item of text in the first description and storing text from the item of text in a data structure that holds data that may be output to a user.

10. The method of claim 9, wherein said first description includes a first item of text at a location that precedes the location of any other item of text defined by said first description; and
wherein the step of executing said particular instruction causes locating the first item of text in the first description.

11. The method of claim 6, wherein the step of executing at least one instruction includes:
executing an instruction that includes a command for establishing a minimum amount of text and a parameter value that specifies said minimum amount; and
wherein executing said particular instruction causes locating an item of text that has at least said minimum amount of text.

12. The method of claim 1, wherein the step of executing at least one instruction includes executing a particular instruction that includes a particular command defined by said second computer language for processing links defined by said first description according to said first computer language.

13. The method of claim 12, wherein the step of executing said particular instruction causes setting a value that indicates the location of a link in said first description that contains one or more strings.

14. The method of claim 13, wherein said particular instruction includes one or more parameters that specify one or more values of said one or more strings.

15. The method of claim 12, wherein the step of executing said particular instruction causes establishing a set of N number of links defined by said first description.

16. The method of claim 15, wherein the step of executing at least one instruction includes executing another instruction that:
includes another command defined by said second computer language, and identifies a specific link from said set of N number of links; and
wherein the step of executing said other instruction causes accessing a resource identified by said specific link from said set of N number of links.

17. The method of claim 16, wherein the other instruction specifies a string used to identify said specific link from said set of N number of links.

18. The method of claim 16, wherein each link in said set of N number of links is associated with a position in said set, wherein the other instruction includes a parameter value that specifies the position of said link from said set of N number of links.

19. The method of claim 12,
wherein said first description defines a table with one or more rows and at least one column that includes one or more links; and
wherein the step of executing said particular instruction causes accessing a resource identified by a link in said at least one column in a particular row from said one or more rows.

20. The method of claim 19, wherein said particular instruction includes a parameter value identifying said at least one column.

21. The method of claim 1, wherein the step of executing at least one instruction includes executing a particular instruction that includes a particular command defined by said second computer language for processing rows in one or more tables defined by said first description according to said first computer language.

22. The method of claim 21, wherein the step of executing said particular instruction causes setting a value in a data structure that indicates the location of a particular row in said first description that contains one or more strings.

23. The method of claim 22, wherein said particular instruction includes one or more parameters that specify one or more values of said one or more strings.

24. The method of claim 22,
wherein the step of executing at least one instruction includes executing another instruction that includes another command defined by said second programming language; and
wherein the step of executing said other instruction causes text from another row residing in a location after said location of said particular row in said first description to be added to a data structure that holds data that may be output to a user.

25. The method of claim 22,
wherein the step of executing at least one instruction includes executing another instruction that includes another command defined by said second programming language; and
wherein the step of executing said other instruction causes text from another row residing in a location before said location of said particular row in said first description to be added to a data structure that holds data that may be output to a user.

26. The method of claim 21, wherein the step of executing said particular instruction causes:
locating a particular row defined by said first description; and
storing text from the particular row in a data structure that holds data that may be output to a user.

27. The method of claim 21,
wherein a row cursor identifies a first location of a first row;
wherein said particular instruction contains one or more parameter string values;
wherein executing said particular instruction causes:
locating a second row that:
resides in said first description at a second location after said first location, and
contains said one or more parameter string values; and
storing text from rows located between said first location and said second location in a data structure that contains data that may be output to a user.

28. The method of claim 1, wherein the step of executing at least one instruction includes executing a particular instruction that includes a particular command for processing one or more fields in one or more forms defined in said first description according to said first computer language.

29. The method of claim 28,
wherein the method further includes the step of storing one or more values for said one or more fields; and
wherein executing said particular command causes submission to a server of said one or more values for said one or more fields.

30. The method of claim 28,
wherein said particular instruction includes one or more parameter values that identify a particular field from said one or more fields; and
wherein executing the particular instruction causes:
prompting the user for user input,
receiving said user input that specifies a particular value, and
storing said particular value in association with said particular field.

31. The method of claim 30,
wherein said particular instruction includes a parameter string value specifying words with which to prompt said user; and
wherein the step of prompting includes causing said words to be conveyed said user.

32. The method of claim 30,
wherein said particular instruction includes a parameter string value identifying a file containing a digital audio data recording of a prompt; and
wherein the step of prompting includes causing said digital audio data to be played to said user.

33. The method of claim 30,
wherein said first description defines, according to said first computer language, said particular field as an enumerated field and value identifiers for the enumerated field; and
wherein executing the particular instruction causes examining said first description to generate data indicating the value identifiers and values associated with said value identifiers.

34. The method of claim 33,
wherein said user input specifies a particular value identifier from among said value identifiers; and
wherein the step of storing said particular value includes storing the value associated with the particular value identifier.

35. The method of claim 33, further including the steps of:
receiving another user command for requesting output of said value identifiers; and
causing generation of user output that specifies at least a portion of said value identifiers in response to receiving said other user command.

36. The method of claim 1, wherein said first computer language is HTML.

37. A computer-readable medium carrying one or more sequences of instructions for enabling access to an interface, wherein execution of the one or more sequences of instructions by one or more processors causes the one or more processors to perform the steps of:
receiving a first description of a user interface that is written in a first computer language and that describes one or more user interface elements;
receiving a second description written in a second computer language that describes one or more user commands and one or more instructions associated with each user command of said one or more user commands;
receiving a user command of said one or more user commands;
in response to receiving said user command, executing at least one instruction of the one or more instructions associated with said user command; and
wherein executing at least one instruction of the one or more instructions causes accessing functionality associated with at least one user interface element described by said first description.

38. The computer-readable medium of claim 37, wherein said user command is a user command conveyed audibly by a user.

39. An apparatus, comprising:
a memory;
one or more processors;
a metabrowser;
said metabrowser configured to receive a first description of a user interface that is written in a first computer language and that describes one or more user interface elements;
said metabrowser configured to receive a second description written in a second computer language that describes one or more user commands and one or more instructions associated with each user command of said one or more user commands;
said metabrowser configured to receive a user command of said one or more user commands;
said metabrowser configured to execute at least one instruction of the one or more instructions associated with said user command in response to receiving said user command; and
wherein said metabrowser executing at least one instruction of the one or more instructions causes said metabrowser to access functionality associated with at least one user interface element described by said first description.

40. The apparatus of claim 39, wherein said user command is a user command conveyed audibly by a user.

41. An apparatus, comprising
a memory;
one or more processors;
means for receiving a first description of a user interface that is written in a first computer language and that describes one or more user interface elements;
means for receiving a second description written in a second computer language that describes one or more user commands and one or more instructions associated with each user command of said one or more user commands;
means for receiving a user command of said one or more user commands;
means for executing, in response to receiving said user command, at least one instruction of the one or more instructions associated with said user command; and
wherein executing at least one instruction of the one or more instructions causes accessing functionality associated with at least one user interface element described by said first description.

42. The apparatus of claim 41, wherein said user command is a user command conveyed audibly by a user.
